(19) United States
(12) Patent Application Publication
(10) Pub. No.: US 2006/0150496 A1
(43) Pub. Date: Jul. 13, 2006

(54) Method and apparatus for growing plants

(76) Inventors: Anton Blaakmeer, Le Venray (NL); Gertus De Sauvage, Rotterdam (NL)

Correspondence Address: DICKSTEIN SHAPIRO MORIN & OSHINSKY LLP, 1177 AVENUE OF THE AMERICAS (6TH AVENUE), 41 ST FL., NEW YORK, NY, 10036-2714, US

(21) Appl. No.: 10/542,334

(22) PCT Filed: Jan. 8, 2004
(86) PCT No.: PCT/EP04/00063

§ 371 Date: Jan. 5, 2006

(30) Foreign Application Priority Data
Jan. 13, 2003 (GB) 0300701.0

(51) Int. Cl. A01G 31/02

(52) U.S. Cl. 47/62 R

(57) ABSTRACT

The invention provides a method of growing plants (2) in a growth substrate comprising supplying water to the growth substrate into a first conduit (4) directly connected at one end (3) to the growth substrate and through the first conduit into a second conduit (5) connected to the other end of the first conduit characterised in that the second conduit is at least partially filled with air and the water is released from the first conduit into air space in the second conduit and in that the growth substrate is formed of organic polymeric foam. The invention also provides an apparatus for carrying out the method.

The invention relates to methods for growing plants in which the rate of flow of irrigation water through the environment of the plant roots is controlled. In particular it relates to methods in which the plants are grown in a growth substrate, in particular an organic polymeric foam growth substrate. It also relates to an apparatus for carrying out the method.

It is well known to cultivate plants in a natural or artificial growth substrate, in particular a mineral wool growth substrate, such as rock wool or glass wool. Other growth substrates, such as phenol urea formaldehyde foam (sold under the name Oasis™) are also known. Water and, if necessary; fertiliser and other additives are supplied to the growth substrate, generally by causing water, optionally containing fertiliser and other additives, to flow through the substrate. It is important, that the plants receive an adequate supply of water, of oxygen and of other materials such as fertiliser which are carried by the water.

Water is one of the means by which oxygen is carried into the growth substrate. In particular, if water is supplied from a dripper positioned above a growth substrate, the drops falling onto the substrate are highly oxygen-rich. This oxygen is carried into the substrate and taken up by the roots of the plant. Therefore if the growth substrate becomes low in oxygen this can be alleviated by supplying more water.

Similar considerations apply to other additives dissolved in the water, such as fertiliser. A greater rate of flow of water into the substrate increases the rate of supply of additives carried by the water.

It is advantageous to have adequate water flow for other reasons. Increased water flow leads to increased turbulence around the roots which increases the rate of transfer of beneficial components such as water and fertiliser into the roots. Flow of water also removes undesirable by-products released into the growth substrate by the plants.

However, merely increasing the rate of supply of water to the growth substrate can cause problems. In particular, the maximum flow rate is normally determined by the maximum flow rate of water through the growth substrate under gravity. If the rate of supply of water exceeds this through-flow rate then excess water simply overflows.

It would be desirable to actively control the rate of flow of water through the substrate. Our earlier publications EP-A-300,536 and EP-A-409,348 disclose active water flow systems which use a mineral wool growth substrate.

EP-A-300,536 discloses a system in which water flow through the mineral wool growth substrate is controlled by a capillary system. Water conduits extend into the growth substrate and connect with a water pump. This is set at a predetermined rate to pump water out of the substrate. The conduit system is substantially filled with water and the flow rate is determined essentially by the rate set for the water pump. This publication discusses “suction pressure” but this is in the context of the force required to be exerted by the plant to remove water from the substrate. High “suction pressure” in this sense correlates with low substrate water content and the aim of this publication is to maintain an appropriate substrate water content and consequently appropriate suction pressure.

EP-A-409,438 relates to the same water pump system. Additionally it provides coupling members between the conduit system and the growth substrate. The intention of these is to prevent growth of plant roots into the conduit system. It is stated that an advantage of the coupling members is that they remain more moist than the surrounding growth substrate and prevent air entering the conduit system from the slab side.

Both of these systems are rather specific to use of mineral wool as the growth substrate, and indeed the system of EP-A-300,356 is designed with the specific porosity and density characteristics of mineral wool in mind. EP-A-409,348 mentions fired clay and sintered porous metals as alternative growth substrates but best results are said to be achieved with mineral wool.

Both the previously described systems require that the surface on which the plants are grown, eg the floor of a greenhouse, is almost exactly horizontal. Otherwise the pressure in the system and the water flow rate vary according to the height at which a slab of mineral wool growth substrate is positioned. A further potential problem lies in the fact that the conduit system is substantially filled with water. Thus there is an unbroken water pathway from one plant to any other plant in the system. This has the potential to allow transfer of plant viruses and other infections throughout the entire crop.

WO94/03046 discloses another system for growing plants in mineral wool. Other “inactive growth media” are generally mentioned but no specific growth substrates other than mineral wool are mentioned. In this system the water content of the mineral wool is kept constant by supplying water to the mineral wool growth substrate via watering pipes and removing it via drain pipes. A common pipe system is used for water supply and drainage. In this system, as in the systems of EP-A-300,536 and EP-A-409,346 discussed above, there is a continuous connection between water in the growth substrate and water in the drainage system.

In our earlier International Patent Application No. PCT/EP02/07741 we describe an improved method of growing plants comprising providing plants, supplying water so that the plant roots contact a body of water, in particular so that the plant roots are in a water-containing growth substrate, and drawing water through a suction device provided in contact with the body of water in the growth substrate and into a first conduit, drawing the water through the first conduit and into a second conduit, wherein the second conduit is at least partially filled with air and the first and second conduits are connected so that the first conduit releases into the air space in the second conduit. The suction device is a liquid drawing and air locking device such as a suction plug inserted into the growth substrate. The suction device is formed of a material which forms an air lock when pressure in the conduit system tends to draw air through it, so that it is completely filled with water and only water passes into the first conduit and air does not pass into the first conduit.

A number of natural and artificial growth substrates are disclosed, including soil, peat, perlite and mineral wool, the latter being preferred. The suction device is made of a porous material and examples include stone, ceramic, mineral wool, porous glass and organic polymer foam or polymer fibres.

In the systems exemplified the growth substrate is stone wool and the suction device is a suction plug inserted into the slab of growth substrates. The first conduit is connected to the suction plug.

However, we have now found that if the growth substrate itself is chosen from a particular class of materials not specifically mentioned for use as the growth substrate in our earlier application, then the growth substrate itself can have the properties of forming an air lock when pressure in the conduit system tends to draw air into the first conduit. As a result, it is surprisingly possible to provide a system which water only is drawn into the first conduit, without drawing of air, without the need for a suction device separate from the growth substrate. Thus the first conduit can be directly attached to the growth substrate itself.

According to the invention we provide a method of growing plants comprising providing plants in a growth substrate, supplying water to the growth substrate, and drawing water into a first conduit provided in direct contact with the growth substrate, drawing the water through the first conduit and into a second conduit, characterised in that the second conduit is at least partially filled with air and the first and second conduits are connected so that the first conduit releases into the air space in the second conduit and in that the growth substrate is formed from organic polymer foam. In preferred embodiments the pressure in the conduits is controlled by an air pump.

Thus in the invention a single integral growth substrate can be used to achieve the benefits of a system in which air pressure controls release of liquid from the substrate whilst using a single integral growth substrate to which the first conduit is directly attached.

The invention thus comprises a liquid drawing and air locking-growth substrate which is attached directly to a conduit system which uses a cavity partly filled with liquid and partly filled with air to induce controlled release of liquid from the substrate. The growth substrate itself is capable of forming an airlock when pressure in the conduit system tends to draw air through it. As the pressure drawing water into the system increases the flow of water increases, generally up to a drawing force of at least 30 cm water column.

The pressure can increase up to a drawing force at which the growth substrate releases air into the first conduit rather than water because the force tending to draw water into the system is greater than the force holding water in the growth substrate.

In the invention the force drawing water into the conduit system is controlled by air pressure. This is in contrast with the systems of EP-A-300,536 and EP-A-409,348 in which the movement of water from the growth substrate into the conduit system is controlled by water flow and is thus influenced by the relative heights of the growth substrate slabs such that if the system is to be effective the slabs must all be on the same level. In the invention it is not necessary to provide a level surface and thus the system may be applied easily and straightforwardly in any greenhouse without requiring levelling of the floor-first.

Furthermore, the first conduit releases into air space in the second conduit. In a preferred embodiment at least two and preferably a large number of conduits are provided, each connected with a different part of the growth substrate in which the roots of the plants are positioned. It is common to provide a large number of slabs of growth substrate each containing one or a small number of plants. In this case, each first conduit is generally associated with a single slab, and in some cases one first conduit can be associated with each plant. Thus although it is possible that viruses and other infectious agents from one plant may be drawn from the growth substrate into the first conduit and then released into the second conduit, there is no water pathway between the second conduit and other first conduits associated with other plants. Thus the risk of transfer of viruses or other infectious agents is much reduced.

With the invention it is possible to control the flow of water through the growth substrate surrounding the plant roots, simply by means of modifying the pressure in the conduit system, eg by means of an air pump and obtain the consequent advantages discussed above, such as control of oxygen supply rate, supply rate of other additives, control of water content, pH, EC (electrical conductivity), nutrients such as nitrogen and microelements, and removal of undesirable by-products.

It is possible to change the air pressure within the conduit system quickly and easily and thus modify flow rates and water content without difficulty.

If the first conduit is connected at the bottom of the growth substrate then water is drawn from the bottom of the substrate and the tendency to water saturation at the bottom of the substrate is reduced.

The invention also provides an apparatus suitable for use in growing plants. This comprises a growth substrate adapted to contain plants and water, the growth substrate being formed from organic polymer foam and connected directly to a first conduit at one end of the first conduit. The first conduit is connected at its other end to a second conduit and the apparatus comprises means for draining water from the second conduit. The apparatus also preferably comprises an air pump arranged to control the air pressure in the conduit system and the apparatus is sized such that the second conduit is at least partially filled with air in use.

### BRIEF DESCRIPTION OF THE DRAWINGS

FIG. 1 shows a schematic view of an apparatus according to the invention.

FIG. 2 shows a cross-section through part of an apparatus according to the invention.

FIG. 3 shows a different cross-section through part of an apparatus according to the invention.

FIG. 4 shows a further schematic view of an apparatus according to the invention.

The plants are generally commercial crops of the type grown in greenhouses. The crop may for instance be lettuce, tomato, cucumber or sweet pepper.

In the invention plants are grown in a growth substrate. That is, the plant roots are positioned within the growth substrate.

In the invention the growth substrate is formed of organic polymer foam. Within the term “foam” we include materials which are, on a micro scale, a three-dimensional mesh. We find that materials of this particular class are able to hold water sufficiently tightly that when the pressure in the conduit system tends to draw air through the growth substrate into the first conduit, only water passes into the first conduit. Examples of polymer materials which can be used include phenol urea formaldehyde foam, urea formaldehyde foam and polyurethane foam, as well as furfuryl alcohol foam and furan foam. One particular phenol urea formaldehyde material is sold under the name Oasis™ and is particularly preferred in the invention. This has a three dimensional mesh structure and other materials of this general structure but formed from different polymer can also be used. Other types of polymer which can be used include those based on urea formaldehyde and polyurethane, as well as furfuryl-alcohol.

The foam can form a single integral mass or can for instance be in the form of foam flakes, eg polyurethane foam flakes.

Organic polymer foam in the form of a fibrous net or mesh is particularly beneficial. A net in which the mesh is formed substantially of square or rectangular mesh in which the distance between cross points is from about 20 to about 100 micrometres, especially about 40 to about 60 micrometres, is preferred.

The strands forming the mesh are preferably in the range 2 to 20 micrometres but particularly preferred strands have thickness at the high end of this range, eg 4 to 20 micrometres. The thickness is preferably from 1/10 to ⅕ of the distance between cross points of the mesh, preferably from ⅛ to ⅕.

The organic polymer foam material should be sufficiently hydrophilic to give the desired capillary action. Certain types of foam are inherently sufficiently hydrophilic to allow this but other types of foam preferably also include a wetting agent.

We find that growth substrates having a density of not more than 35 kg/m³ are preferred, with density not more than 30 kg/³, preferably not more than 28 kg/m³, being more preferred. A density of about 25 kg/m³ is particularly useful. Density is usually at least 5 kg/m³, preferably at least 10 and more preferably at least 15 kg/m³. The most preferred density can vary according to the type of polymer foam. For phenol urea formaldehyde foam the preferred density is from 15 to 35 kg/m³¹ preferably 20 to 30 kg/m³. Urea formaldehyde foam preferably has a density from 5 to 25 kg/m3, preferably 10 to 20 kg/m³. Polyurethane foam and furan foam preferably have a density of from 15 to 35 kg/m³. Polyurethane foam flakes preferably have density from 50 to 90 kg/m³, preferably from 60 to 80 kg/m3.

The polymer foam generally has an open foam structure.

The growth substrate generally holds water more tightly than air. Preferably it holds water against a force of at least 5 cm water column, preferably at least 10 cm water column, more preferably at least 20 cm water column, most preferably at least 30 cm water column. Some may hold water against a force of up to 200 cm water column.

Where the pressure in the second conduit is below atmospheric (preferred) generally the growth substrate holds water more tightly than air at a water column value determined by: the elevation of the second conduit-above the point at which the first conduit is connected to the growth substrate subtracted from the difference in pressure in the second conduit below atmospheric (often referred to as the underpressure). In practice, the growth substrate holds water against a force substantially equal to the underpressure in the second conduit.

In order to determine whether any particular polymer foam would be suitable as the material for the growth substrate it is simply necessary to test its, ability to hold water against the water column values above.

The growth substrate can be described as substantially air locking. That is, it does not permit passage of substantial amounts of air through the water in contact with the roots and into the first and second conduits.

The growth substrate may contain other additives known in the art for modifying and improving properties, such as clay or lignite.

In the method water is supplied to the growth substrate. This may be by any conventional means, eg drip feeding. This method is particularly preferred because the water is oxygen-rich when it reaches the growth substrate. Irrigation may be continuous or periodic. The water may contain fertilisers, biologically active additives such as fungicides, and other additives.

In the invention the growth substrate is capable of taking in water against pressure. Thus, although the invention can include a system for applying vacuum or pumping the suction device is such that this is not essential and water can be taken in without it. In particular it is capable of holding water by capillary force.

In the invention the air pressure in the first and second conduits is generally predetermined and is preferably below atmospheric pressure. Entry of air into the second conduit will affect and modify this pressure to some extent. This also has the effect of subjecting different parts of the growth substrate in a single system to different air pressures, which the invention seeks to avoid. However, in systems in which the pressure is significantly below atmospheric eg about 0.5 bar (5000 cm water column) then a low degree of passage of air into the first conduit is not problematic. Thus the growth substrate is air locking to the extent that it prevents entry of substantial amounts of air into the second conduit which have a substantial effect on th air pressure in the second conduit.

The growth substrate is connected to one end of a first conduit, which generally has a narrow diameter. Inner diameter is preferably from 1 to 10 mm, more preferably from 2 to 6 mm, in particular about 4 mm.

The first conduit is connected directly to the growth substrate. That is, water passes from the growth substrate into the first conduit without passing through any other material. The connection can be made secure by any appropriately secure means but generally simply pushing the end of the first conduit into the growth substrate is sufficient. Thus, in contrast with our earlier application PCT/EP02/07741, the first conduit does not contact a suction device which is then in contact with the growth substrate.

The other end of the first conduit is connected to a second conduit. In the invention it is essential that the second conduit is at least partially filled with air. This allows the pressure in the system to be controlled by an air pump. It is also essential that the first conduit discharges into air space in the second conduit so that in the preferred system where several first conduits feed into a single second conduit there is no continuous water pathway between plants. The first conduit can be connected with the top of the second conduit, but any connection point can be used. Generally it is preferred that the first conduit is horizontal at the point at which it joins the second conduit. Generally also the first conduit is substantially full of water during water flow in use.

The relative volumes of air and water in the conduit system will vary according to the required water flow and the dimensions of the conduits. However, preferably not more than 80%, more preferably not more than 60%, in particular not more than 40%, of the internal volume of the conduit system is taken up by water. Most preferably less than 20%, in particular less than 10%, of the internal conduit volume is taken up by water.

The pressure in the conduit system is generally from 20000 Pa below to 20000 Pa above atmospheric pressure, preferably from 10000 Pa below to 10000 Pa above atmospheric pressure. It is preferably below atmospheric pressure, for instance from 5 to 5000 Pa below atmospheric pressure.

It is possible to provide a system in which the air pressure within the conduits is above atmospheric, provided that the discharge point from the first conduit into the second conduit is at a lower elevation than the point at which the first conduit is connected with the growth substrate. This means that gravitational force causes the water to move from the suction plug to the second conduit. Pressure above atmospheric pressure will reduce this tendency but provided that the overall force-causes water to tend to move to the second conduit then any combination of elevation and air pressure may be used.

If the pressure in the conduit system is below atmospheric pressure then the discharge point from the first conduit into the second conduit may be at a greater elevation than the point at which the first conduit is connected with the growth substrate.

For optimum operation of the preferred system comprising two or more first conduits, the two or more first conduits discharging into a single second conduit, the difference in elevation between the point at which each first conduit is connected to the growth substrate and the point at which it discharges into the second conduit should be the same for each first conduit. It is not necessary that all the connection points are at the same elevation as each other or that all of the discharge points are at the same elevation as each other. However the relative elevation of the two ends of the first conduit should be essentially the same for all first conduits.

It will be seen that the skilled person will be able to choose the relative elevations of the ends of the first conduit and the air pressure in the conduit system so as to obtain the desired force to draw water from the growth substrate to the second conduit.

It is preferred that the height of the discharge point from the first conduit into the second conduit is no lower than any other point in the first conduit. That is, preferably no part of the first conduit is at a higher elevation than the discharge point into the second conduit.

Preferably the system comprises a number of slabs of growth substrate each provided with a first conduit, all of the first conduits leading into a single second conduit. More preferably a series of such systems is provided so that at least two, generally several second conduits all feed into a single third conduit. Water then flows into the third conduit, in which is positioned a siphon which removes water from the system. The siphon is preferably placed at the lowest point of the third conduit.

The second conduit may be positioned at any angle provided that it allows water to flow out of the system or, as is preferable, into a third conduit. Generally it is positioned at an angle of from 0 to 45° with the horizontal.

The water siphoned from the system is generally recycled, usually after disinfection.

The system may be started by any suitable means for inducing the initial flow of water into the first conduit, eg use of and air pump or other suction means or even gravity alone. In well-sealed systems no additional means for reducing or increasing air pressure is necessary, but in practice it is often convenient to include such means to control pressure in the system over a long period of time.

An air pump is preferably used to control pressure in the system and may be connected at any point in the conduit system, usually to the second or third conduit. It is often convenient to connect it to the third conduit if used. The air pump is regulated to control the air pressure within the desired range within the system.

In the invention water is drawn from the growth substrate into the conduit system by means of adjusting the forces so that the water tends to travel from the growth substrate to the second conduit. It will also be seen that it is possible to produce a system in which the pressure in the conduit system is great enough that air will be forced into the growth substrate. This can increase the oxygen level of the water around the roots in a different way.

The system of the invention may be used in any cultivation method. It is particularly useful for controlling water flow rate in the oxygen management system discussed in our co-pending International Patent Application Number PC/EP02/07881.

A system of the invention will now be illustrated by reference to the drawings.

### DETAILED DESCRIPTION OF THE DRAWINGS

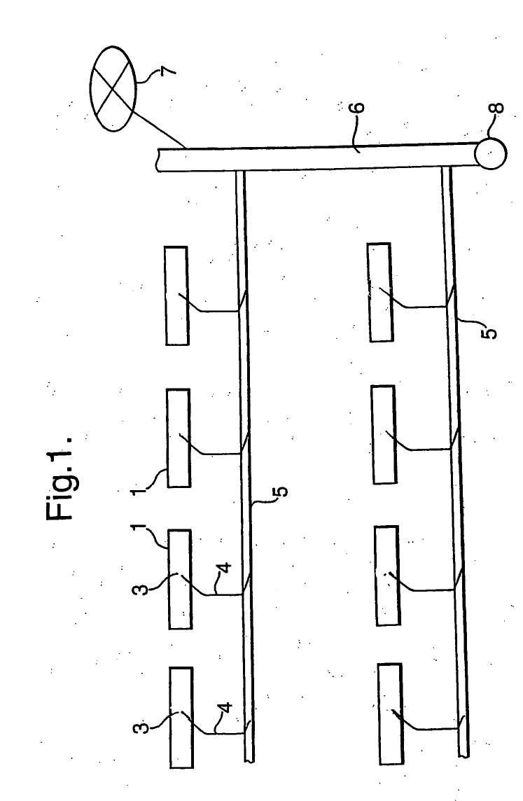

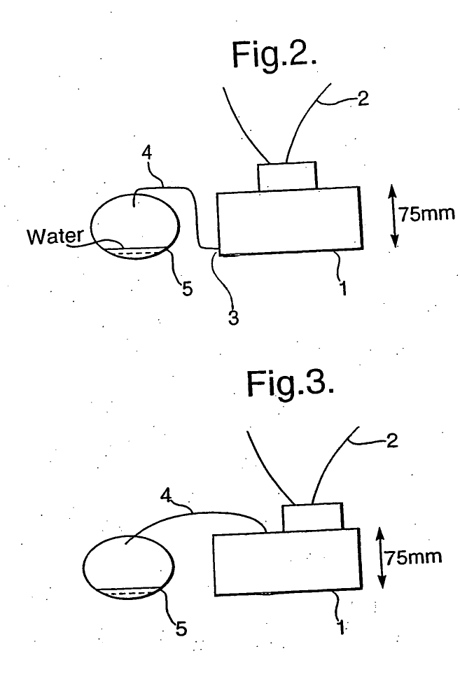

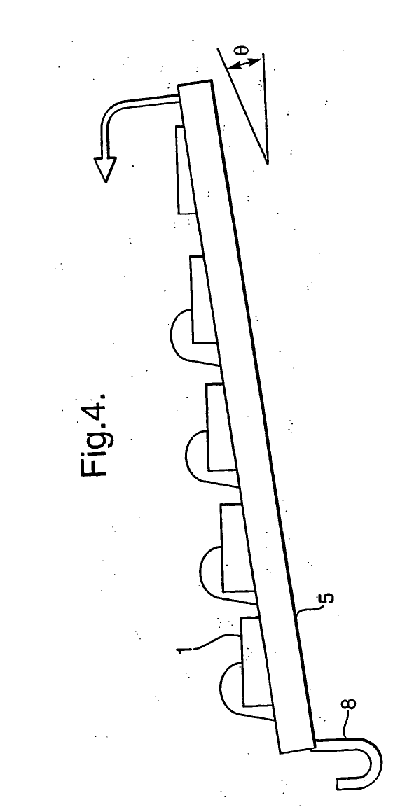

FIG. 1 shows a series of slabs 1 of polymer foam growth substrate. In each slab 1 a plant 2 is placed for growth (see FIG. 2). Each slab is directly connected with a first conduit 4 at connection point 3. The first conduits 4 all join a single second conduit 5, described as a lateral conduit. In a preferred system there is a series of lateral conduits 5 into each of which a series of first conduits feed water. Two lateral conduits 5 are shown in FIG. 1. The lateral conduits 5 all feed into a third conduit 6. The third conduit is described as a main conduit. Connected to this main conduit 6 is an air pump 7. At the lowest point of the main conduit 6 is a siphon 8 used to remove water.

The first conduits 4 generally have inner diameter from 1 to 10 mm, preferably about 4 mm. The second lateral conduits 7 generally have inner diameter from 20 to 80 mm, preferably from 40 to 80 mm.

The system is set up as follows. The siphon 8 is filled with water. The slabs 1 are filled with water. The air pump 7 is then started so as to lower the air pressure in the conduit system. The air pressure is lowered to, for example, about 1000 Pa below atmospheric pressure. Consequently water from the slabs 1 is drawn into the first conduits 4 as a result of the lower pressure in the conduit system and drips into the lateral conduit 5 at the top of the lateral conduit 5. FIG. 2 has a cross-section through lateral conduit 5 showing the air space and the water flowing along the bottom of the conduit. Thus the water removed from each slab is isolated from all other slabs. The water flows along the base of the lateral conduit 5 and into the main conduit 6′. Water is removed from the system by means of the siphon 8, which allows water to exit regardless of the air pressure and without influencing the air pressure.

In the illustrated system the point at which the first conduits 4 discharge into the lateral conduits 5 is at a greater elevation than the connection points 3. Thus in order to draw water through the first conduit 4 it is necessary that the air pressure is below atmospheric pressure to a sufficient extent to raise the water through the required elevation. The relative elevation is the same for all first conduits. Thus the pressure in the conduit system may even be atmospheric pressure, provided that the overall force on the water tends to draw it from the growth substrate to the lateral conduit 5.

The siphoned water is usually disinfected and recirculated.

1. A method of growing plants in a growth substrate comprising supplying water to the growth substrate, drawing water into a first conduit directly connected at one end to the growth substrate and through the first conduit into a second conduit connected to the other end of the first conduit, characterised in that the second conduit is at least partially filled with air and the water is released from the first conduit into air space in the second conduit and in that the growth substrate is formed of organic polymeric foam.

2. A method according to claim 1 in which the pressure in the conduits is controlled by an air pump.

3. A method according to claim 1 in which the organic polymer foam is selected from phenol urea formaldehyde foam, urea formaldehyde foam, polyurethane foam, furan foam and furfuryl alcohol foam.

4. A method according to claim 1 in which the inner diameter of the first conduit is from 6 to 50%, of the inner diameter of the second conduit.

5. A method according to claim 1 in which the conduits are sized and the rate of flow of water is controlled so that the water takes up not more than 20% of the internal volume of the conduit system.

6. A method according to claim 1 in which the growth substrate is in the form of two or more slabs each of which is directly connected with a first conduit whereby at least two first conduits are connected with a single second conduit.

7. A method according to claim 2 in which at least two second conduits are provided and these lead into a single third conduit to which is connected the air pump.

8. A method according to claim 1 in which water is removed from the conduit system by a siphon.

9. A method according to claim 1 in which the air pressure in the conduit system is below atmospheric pressure.

10. A method according to claim 1 in which the second conduit is substantially straight and is positioned at an angle of from 0 to 45° with the horizontal and has at all points elevation above the elevation of the growth substrate.

11. A method according to claim 1 in which the second conduit is substantially straight and is positioned at an angle of from 0 to 45° with the horizontal and has an elevation at all points below the elevation of the growth substrate.

12. A method according to claim 1 in which the growth substrate holds water against a force of at least 5 cm water column.

13. A method according to claim 1 in which the growth substrate has a density of from 5 to 35 kg/m³.

14. A method according to claim 1 in which the growth substrate is in the form of a mesh of polymer strands.

15. A method according to claim 14 in which the cross points of the mesh are from 20 to 100 micrometres apart.

16. A method according to claim 15 in which the strands of the mesh have thickness from 1/10 to ⅕ of the distance between the cross points of the mesh.

17. An apparatus in which plants may be grown comprising an organic polymer foam growth substrate adapted to contain plants, the growth substrate being directly connected with a first conduit arranged to draw water from the growth substrate and a second conduit connected to an end of the first conduit which is not connected with the growth substrate and the second conduit having a water drain, and the apparatus is sized so that the second conduit is at least partially filled with air in use.

18. An apparatus according to claim 17 additionally comprising an air pump arranged to control the air pressure within the first and second conduits.

19. An apparatus according to claim 17 additionally comprising a water supply adapted to supply water to the growth substrate.

20. An apparatus according to claim 17 in which the inner diameter of the first conduit is from 6 to 50% of the diameter of the second conduit.

21. An apparatus according to claim 17 additionally comprising a third conduit connected with the second conduit.

22. An apparatus according to claim 21 in which the second conduit water drain comprises a siphon provided at the lowest point of the third conduit.

23. An apparatus according to claim 17 in which the growth substrate is formed from phenol urea formaldehyde foam, polyurethane foam or furfuryl alcohol foam.

24. A growth substrate which contains plants and which is a liquid drawing and air locking device and which is directly connected to a conduit system which is partially filled with liquid and partially filled with air and the conduit system is adapted to induce controlled release of liquid from the growth substrate.

25. An apparatus according to claim 19 additionally comprising an air pump arranged to control the air pressure within the first and second conduits, and in which the water supply comprises a dripper system, and the inner diameter of the first conduit is from 7 to 30% of the diameter of the second conduit.

26. A method according to claim 2 in which the organic polymer foam is phenol urea formaldehyde foam which holds water against a force of at least 10 cm water column, the inner diameter of the first conduit is from 7 to 30% of the inner diameter of the second conduit, the conduits are sized and the rate of flow of water is controlled so that the water takes up not more than 10% of the internal volume of the conduit system, and the air pressure in the conduit system is below atmospheric and up to 20,000 Pa below atmospheric pressure.
